(19) United States
(12) Patent Application Publication
(10) Pub. No.: US 2024/0231755 A1
(43) Pub. Date: Jul. 11, 2024

(54) METHOD FOR COMPRESSING FLOATING-POINT NUMBERS, COMPUTING DEVICE AND COMPUTER-READABLE MEDIUM

(71) Applicant: National Tsing Hua University, Hsinchu (TW)

(72) Inventors: Yun-Chen Lo, Hsinchu (TW); Ren-Shuo Liu, Hsinchu (TW)

(21) Appl. No.: 18/202,295

(22) Filed: May 26, 2023

Related U.S. Application Data
(60) Provisional application No. 63/345,918, filed on May 26, 2022.
(60) Provisional application No. 63/426,727, filed on Nov. 19, 2022.

(30) Foreign Application Priority Data
May 25, 2023 (TW) 112119580

(51) Int. Cl. G06F 7/499

(52) U.S. Cl. CPC G06F 7/49915

(57) ABSTRACT

A method of compressing floating points includes using an arithmetic unit to perform following steps: obtaining a plurality of floating-point numbers; producing scaling factors from the floating-point numbers; compressing each of the floating-point numbers into a plurality of fixed-point mantissas; outputting a compression result that includes the plurality of scaling factors and the plurality of fixed-point mantissas.

### FIELD OF THE INVENTION

The invention relates to the application of floating-point number operations, and more particularly, to a floating-point number operation method and related arithmetic units.

### BACKGROUND OF THE INVENTION

With the huge amount of floating-point computation brought by the more and more extensive field of Machine Learning, how to compress floating-point data to increase operational speed and reduce power consumption has become a hot issue in this field. Conventional floating-point technologies so far are to completely store and calculate multiple floating-point numbers individually, that is, completely stores the sign, exponent and mantissa for each floating-point number. In this way, it not only consumes a huge amount of storage space due to storing a large amount of data, but also increases transmission time and power consumption in operations.

Microsoft has provided a floating-point number compression method known as Microsoft Floating Point (MSFP), which forcibly compressing multiple exponents of multiple floating-point numbers into a single exponent to simplify the whole operation process. However, once the compression error is too large, it can lead to a sharp decline in the accuracy of the operation. As the machine learning applications (e.g., neural algorithms) demand on a certain level of accuracy in operations, the MSFP method is nonideal.

In view of the above, there is a need for a novel floating-point arithmetic method and hardware architecture to solve the aforementioned problems encountered in related art techniques.

### SUMMARY OF THE INVENTION

To solve the above issues, an objective of the present invention is to provide an efficient floating-point number compression (or encoding) method, so as to improve the shortcomings of conventional floating-point number compression method without greatly increasing the cost, thereby improving the overall operational speed and reducing the power consumption.

An embodiment of the invention provides a floating-point number compression method, which comprises the following steps: A) obtaining b floating-point numbers f1-fb, where b is a positive integer greater than 1; B) generating k common scaling factors r1-rk for the b floating-point numbers, where k is a positive integer equal to or greater than 1, and the k common scaling factors r1-rk at least comprise a floating-point number with a mantissa; C) compressing each floating-point number fi in the b floating-point numbers into k fixed-point mantissas mi_1-mi_k, to generate b×k fixed-point mantissas mi_j, where i is a positive integer not greater than b, and j is a positive integer not greater than k; and D) outputting a compression result, wherein the compression result comprises the k common scaling factors r1-rk and the b×k fixed-point mantissas mi_j representing b compressed floating-point numbers cf1-cfb, and the value of each compressed floating-point number cfi is represented as cfi=Σⱼ₌₁^{k}(rj×mi_j).

Alternatively, according to an embodiment of the present invention, the arithmetic device (also referred to as computing device) further performs the following steps before performing Step D): generating a quasi-compression result, wherein the quasi-compression result comprises the k common scaling factors r1-rk and the b×k fixed-point mantissas mi_j, and calculating a compression error for the quasi-compression result; setting a threshold value; and according to the compression error and the threshold value, adjusting the k common scaling factors r1-rk and the b×k fixed-point mantissas mi_j.

Alternatively, according to an embodiment of the present invention, the step of calculating the compression error for the quasi-compression result comprises: calculating the compression error Ei for each of the b floating-point numbers fi according to the following equation: Ei=fi−Σⱼ₌₁^{k}(rj×mi_j); calculating a sum of squares SE of b errors E1-Eb according to the following equation: SE=Σᵢ₌₁^{b} Ei\hat{ }2, and comparing the sum of squares SE with a threshold; wherein if the sum of squares SE is not greater than the threshold, the quasi-compression result is taken as the compression result.

Alternatively, according to an embodiment of the present invention, if the compression error is greater than the threshold, Steps B) and C) are re-executed.

Alternatively, according to an embodiment of the present invention, the step of adjusting the k common scaling factors r1-rk and the b×k fixed-point mantissas mi_j comprises: iteratively performing one of the Heuristic algorithm, Randomized algorithm, and Brute-force algorithm upon the k common scaling factors r1-rk and the b×k fixed-point mantissas mi_j.

Alternatively, according to an embodiment of the present invention, the step of setting the threshold comprises: extracting common scaling factors r1′-rk′ from the b floating-point numbers; compressing each floating-point number fi in the b floating-point numbers into k fixed-point mantissas mi_1′-mi_k′, to generate b×k fixed-point mantissas mi_j′; calculating a compression error Ei′ for each floating-point number fi of the b floating-point numbers according to the following equation: E1′=fi−Σⱼ₌₁^{k}(rj′×mi_j′); calculating a sum of squares SE′ of b errors E1′-Eb′ according to the following equation: SE′=Σᵢ₌₁^{b} Ei′\hat{ }2; and setting the threshold as the compression error SE′.

Alternatively, according to an embodiment of the present invention, the b×k fixed-point mantissas mi_j are all unsigned numbers.

Alternatively, according to an embodiment of the invention, at least one of the b×k fixed-point mantissas mi_j is a signed number, and the numerical range expressed by the signed number is asymmetric with respect to 0.

Alternatively, according to an embodiment of the invention, the signed number is a 2's complement number.

Alternatively, according to an embodiment of the present invention, the method further comprises: storing the b×k fixed-point mantissas mi_j and the k common scaling factors in a memory of a network server for remote downloads.

Alternatively, according to an embodiment of the present invention, the method further comprises: storing the b×k fixed-point mantissas mi_j and all the scaling factors r1-rk in a memory, with part of the b×k fixed-point mantissas mi_j and part of the scaling factors r1-rk not participating in operations.

Alternatively, according to an embodiment of the present invention, k is equal to 2, and each of the scaling factors r1-rk is floating-point numbers with no more than 16 bits.

Alternatively, according to an embodiment of the invention, Step D) comprises: calculating a quasi-compression result, wherein the quasi-compression result comprises the k common scaling factors r1-rk and the b×k fixed-point mantissas mi_j; calculating a compression error for the quasi-compression result; setting a threshold value; and adjusting the quasi-compression result according to the compression error and the threshold, as the compression result.

An embodiment of the invention provides an arithmetic device. The arithmetic device comprises a first register, a second register and an arithmetic unit. The arithmetic unit comprises at least one multiplier and at least one adder, and the arithmetic unit is coupled to the first register and the second register. The first register stores b activation values a1-ab, where b is a positive integer greater than 1. The second register stores b compressed floating-point numbers cf1-cfb. The b packed floating-point numbers comprise k common scaling factors r1-rk, where k is a positive integer equal to or greater than 1. Each of the b compressed floating-point numbers cfi comprises k fixed-point mantissas mi_1-mi_k, the b compressed floating-point numbers cfi have b×k fixed-point mantissas mi_j, where i denotes a positive integer not greater than b and j denotes a positive integer not greater than k, and the value of each compressed floating-point number cfi is expressed by: cfi=Σⱼ₌₁^{k}(rj×mi_j). The arithmetic unit calculates an inner product result of the b activation values (a1, a2, . . . , ab) and the b compressed floating-point numbers (cf1, cf2, . . . , cfb).

Alternatively, according to an embodiment of the present invention, the arithmetic device is configured to perform the following steps: A) obtaining b floating-point numbers f1-fb, wherein b is a positive integer greater than 1; B) generating k common scaling factors r1-rk for the b floating-point numbers, where k is a positive integer greater than 1, and the k common scaling factors r1-rk at least comprise a floating-point number with a mantissa; C) compressing each floating-point number fi in the b floating-point numbers into k fixed-point mantissas mi_1-mi_k to generate b×k fixed-point mantissas mi_j, where i is a positive integer not greater than b, and j is a positive integer not greater than k; and D) outputting a compression result, wherein the compression result comprises the k common scaling factors r1-rk and the b×k fixed-point mantissas mi_j representing b compressed floating-point numbers cf1-cfb, and the value of each compressed floating-point number cfi is represented by cfi=Σⱼ₌₁^{k}(rj×mi_j).

Alternatively, according to an embodiment of the present invention, the arithmetic device further performs the following steps before performing Step D): calculating a quasi-compression result, wherein the quasi-compression result comprises the k common scaling factors r1-rk and the b×k fixed-point mantissas mi_j; calculating a compression error for the quasi-compression result; setting a threshold value; and adjusting the k common scaling factors r1-rk and the b×k fixed-point mantissas mi_j according to the compression error and the threshold value.

Alternatively, according to an embodiment of the present invention, the step of calculating the compression error for the quasi-compression result comprises: calculating a compression error Ei for each floating-point number fi in the b floating-point numbers according the following equation: Ei=fi−Σⱼ₌₁^{k}(rj×mi_j); calculating a sum of squares SE of b errors E1-Eb according to the following equation: SE=Σᵢ₌₁^{b} Ei\hat{ }2; and comparing the sum of squares SE with a threshold; wherein if the sum of squares SE is not greater than the threshold, the quasi-compression result is taken as the compression result.

Alternatively, according to an embodiment of the present invention, if the compression error is greater than the threshold, Steps b) and c) are re-executed.

Alternatively, the step of adjusting the k common scaling factors r1-rk and the b×k fixed-point mantissas mi_j comprises: iteratively performing one of the Heuristic algorithm, Randomized algorithm, and Brute-force algorithm upon the k common scaling factors r1-rk and the b×k fixed-point mantissas mi_j.

Alternatively, according to an embodiment of the present invention, the step of setting the threshold comprises: extracting common scaling factors r1′-rk′ from the b floating-point numbers; compressing each floating-point number fi in the b floating-point numbers into k fixed-point mantissas mi_1′-mi_k′, to generate b×k fixed-point mantissas mi_j′; calculating a compression error Ei′ for each floating-point number fi of the b floating-point numbers according to the following equation: Ei′=fi−Σⱼ₌₁^{k}(rj′×mi_j′); calculating the sum of squares SE′ of b errors Ei′-Eb′ according to the following equation: SE′=Σᵢ₌₁^{b} Ei′\hat{ }2; and setting the threshold as the compression error SE′.

Alternatively, according to an embodiment of the present invention, the b activation values a1-ab are integers, fixed points, or mantissas of MSFP block floating-point numbers.

Alternatively, according to an embodiment of the present invention, all the b×k fixed-point mantissas mi_j and all the common scaling factors r1-rk are stored in the second register, with part of the b×k fixed-point mantissas mi_j and part of the scaling factors r1-rk not participating in operations.

An embodiment of the present invention provides a computer-readable storage medium that stores computer-readable instructions executable by a computer, wherein when being executed by the computer, the computer-readable instructions trigger the computer to output b compressed floating-point numbers, where b is a positive integer greater than 1; the method comprising: A) generating k common scaling factors r1-rk, where k is a positive integer equal to or greater than 1, wherein the k common scaling factors r1-rk at least comprise a floating-point number with a scaling factor exponent and a scaling factor mantissa; B) generating k fixed-point mantissas mi_1-mi_k to generate b×k fixed-point mantissas mi_j, where i is a positive integer not greater than b, and j is a positive integer not greater than k; and C) outputting the k common scaling factors r1-rk and the b×k fixed-point mantissas mi_j representing b compressed floating-point numbers cf1-cfb, wherein the value of each compressed floating-point number cfi is represented by cfi=Σⱼ₌₁^{k}(rj×mi_j).

In view of the above, the invention can save storage space, reduce power consumption and speed up operation while meeting the accuracy requirements of various application programs. In addition, due to the adjustability between the first mode and the second mode, the electronic products adopting the proposed technical features can flexibly make a trade-off between a high-efficiency mode and a low-power mode, so that the electronic products can be applied in more areas. In addition, compared with the Microsoft MSFP as well as other existing technologies, the method of compressing floating-point numbers of the present invention can provide optimized operation efficiency and accuracy, which can reduce the power consumption and speed up the processing speed while also meeting the accuracy requirements of application programs.

### BRIEF DESCRIPTION OF THE DRAWINGS

FIG. 1 is a diagram illustrating an operation of floating-point numbers according to a related art technique.

FIG. 2 is a diagram illustrating an arithmetic unit applicable to an arithmetic device according to an embodiment of the present invention.

FIG. 3 is a diagram illustrating a MSFP-based compression process method according to a related art technique.

FIG. 4 is a diagram illustrating a compression process of an arithmetic unit according to an embodiment of the present invention.

FIG. 5 is a diagram illustrating a compression process of an arithmetic unit according to another embodiment of the present invention.

FIG. 6 is a diagram illustrating the floating-point multiplication of weight values and activation values by using an arithmetic unit and register according to an embodiment of the present invention.

FIG. 7 is a flowchart illustrating a method of compressing floating-point numbers according to an embodiment of the present invention.

FIG. 8 is a diagram illustrating the comparison between the method of the present invention and the method of MSFP.

### DETAILED DESCRIPTION OF PREFERRED EMBODIMENTS

The present disclosure is particularly described by following examples that are mainly for illustrative purposes. For those who are familiar with the technologies, various modifications and embellishments can be made without departing from the spirit and scope of the present disclosure, and thus the scope of the present disclosure shall be subject to the content of the attached claims. In the entire specification and claims, unless clearly specified, terms such as “a/an” and “the” can be used to describe “one or at least one” assembly or component. In addition, unless the plural use is obviously excluded in the context, singular terms may also be used to present plural assemblies or components. Unless otherwise specified, the terms used in the entire specification and claims generally have the common meaning as those used in this field. Certain terms used to describe the disclosure will be discussed below or elsewhere in this specification, so as to provide additional guidance for practitioners. The examples throughout the entire specification as well as the terms discussed herein are only for illustrative purposes, and are not meant to limit the scope and meanings of the disclosure or any illustrative term. Similarly, the present disclosure is not limited to the embodiments provided in this specification.

The terms “substantially”, “around”, “about” or “approximately” used herein may generally mean that the error of a given value or range is within 20%, preferably within 10%. In addition, the quantity provided herein can be approximate, which means that unless otherwise stated, it can be expressed by the terms “about”, “nearly”, etc. When the quantity, concentration, or other values or parameters have a specified range, a preferred range, or upper and lower boundaries listed in the table, they shall be regarded as a particular disclosure of all possible combinations of ranges constructed by those upper and lower limits or ideal values, no matter such kind of ranges have been disclosed or not. For example, if the length of a disclosed range is X cm to Y cm, it should be regarded as that the length is H cm, and H can be any real number between x and y.

In addition, the term “electrical coupling” or “electrical connection” may include direct and indirect means of electrical connection. For example, if the first device is described as electrically coupled to the second device, it means that the first device can be directly connected to the second device, or indirectly connected to the second device through other devices or means of connection. In addition, if the transmission and provision of electric signals are described, those who are familiar with the art should understand that the transmission of electric signals may be accompanied by attenuation or other non-ideal changes. However, unless the source and receiver of the transmission of electric signals are specifically stated, they should be regarded as the same signal in essence. For example, if the electrical signal S is transmitted from the terminal A of the electronic circuit to the terminal b of the electronic circuit, which may cause voltage drop across the source and drain terminals of the transistor switch and/or possible stray capacitance, but the purpose of this design is to achieve some specific technical effects without deliberately using attenuation or other non-ideal changes during transmission, the electrical signals S at the terminal A and the terminal b of the electronic circuit should be substantially regarded as the same signal.

The terms “comprising”, “having” and “involving” used herein are open-ended terms, which can mean “comprising but not limited to”. In addition, the scope of any embodiment or claim of the present invention does not necessarily achieve all the purposes, advantages or features disclosed in the present invention. In addition, the abstract and title are only used to assist the search of patent documents, and are not used to limit the scope of claims of the present invention.

Neural-based algorithms generally involve massive floating-point multiplication of weights and activations. Hence, how to properly compress floating-point numbers while meeting the accuracy demands is of vital importance.

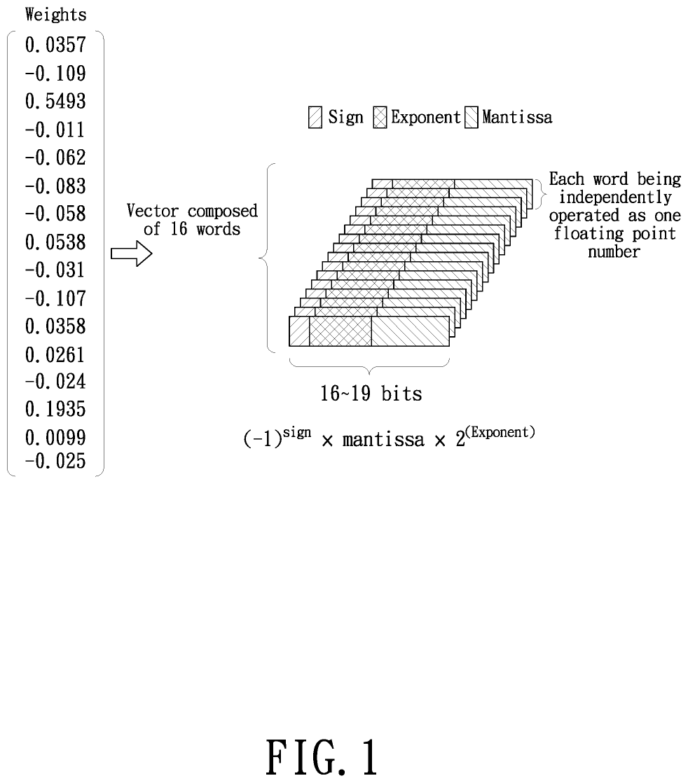

Please refer to FIG. 1, which is a diagram illustrating an operation of floating-point numbers according to a related art technique. As shown in FIG. 1, the weights are an array (or vector) containing 16 words, which can be represented by the floating-point numbers on the right. Each floating-point number is divided into a sign, exponent and mantissa stored in three different columns of a register. When decoding, a floating-point number is decoded into:

$$\\ {( - 1 )}^{{}_{} Sign} \times ( 1. Mantissa ) \times {2}^{{}_{} Exponent}$$

where Sign denotes the sign of the floating-point number, and Exponent represents the exponent of this floating-point number. The mantissa is also called a significand. When stored in a register, the leftmost bit of the register is allocated as a sign bit to store the sign, and the remaining bits (e.g., 15-18 bits) are allocated as exponent bits and mantissa bits to store the exponent and mantissa respectively. In related art techniques, each word is treated as a floating-point number for operation and storage, and thus the register must store 16-19 bits for each word, which is time-consuming in operation and involves the use of more complex hardware circuits. This could result in lower performance, higher cost and higher power consumption. Please note that the number of bits in the architecture mentioned in the full text or depicted in the drawings is only for illustrative purposes, and is not meant to limit the scope of the invention. In practice, the number of bits in the above example can be increased or decreased according to actual design requirements.

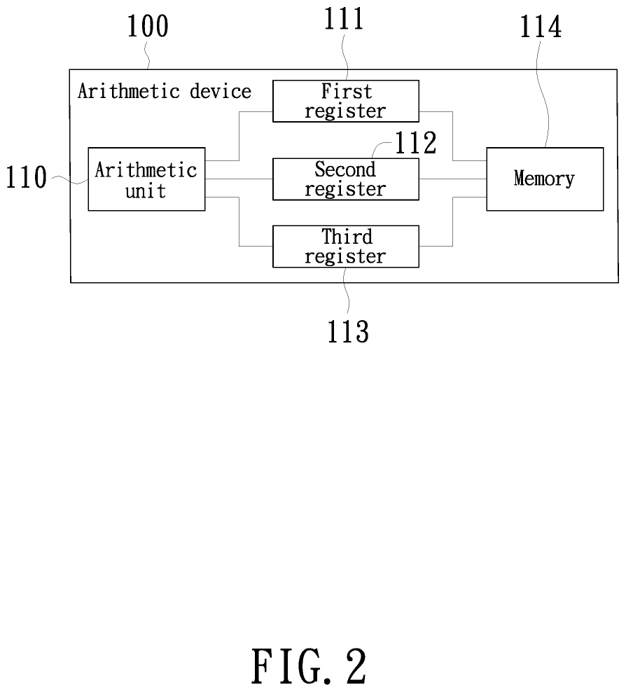

Please refer to FIG. 2, which is a diagram illustrating an arithmetic unit 110 applied to the arithmetic device 100 according to an embodiment of the present invention. As shown in FIG. 2, the arithmetic device 100 comprises an arithmetic unit 110, a first register 111, a second register 112, a third register 113 and a memory 114. The arithmetic unit 110 is coupled to the first register 111, the second register 112 and the third register 113, and the memory 114 is coupled to the first register 111, the second register 112 and the third register 113. It is worth noting that the memory 114 is merely a general name of the memory cells in the arithmetic device 100, that is, the memory 114 can represent either a stand-alone memory unit, or the overall memory cells in the arithmetic device 100. For example, the first register 111, the second register 112 and the third register 113 may be respectively coupled to different memories. The arithmetic device 100 can be any device with computing capability, such as a central processing unit (CPU), a graphics processor (GPU), an artificial intelligence (AI) accelerator, a programmable logic array (FPGA), a desktop computer, a notebook computer, a smart phone, a tablet computer, a smart wearable device, etc. Under some conditions, the mantissas of floating points stored in the first register 111 and the second register 112 can be discarded by the present invention without being stored in the memory 114, thereby saving memory space. In addition, the memory 114 can store a plurality of groups of batch normalization coefficients respectively correspond to a plurality of candidate thresholds, and the exponent threshold is selected from one of the candidate thresholds. The batch normalization coefficient is a kind of coefficient for adjusting the average and standard deviation of numerical values in AI operations. Generally, a piece of numerical data of a feature map corresponds to a set of specific batch normalization coefficients.

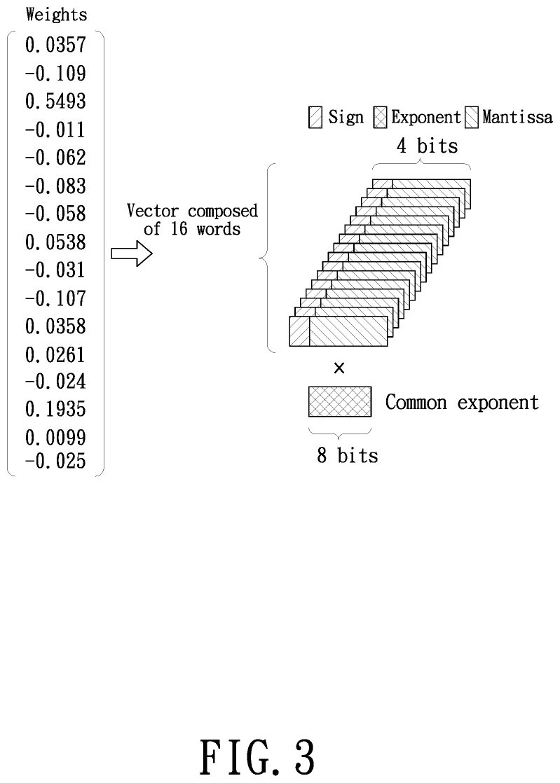

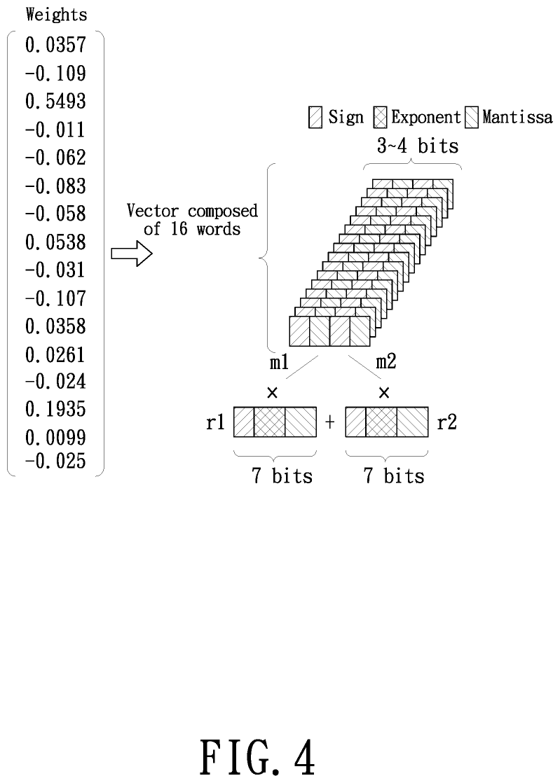

Please refer to FIG. 3, which is a diagram illustrating a MSFP-based compression process method according to a related art technique. As shown in FIG. 3, when compressing 16 floating-point numbers, the MSFP approach takes “block” as the unit instead of taking one floating-point number as the unit, in which the common exponent part of the 16 floating-point numbers is extracted (marked as 8-bit common exponent in the figure). After the common exponent is extracted, the floating-point numbers only have the sign part and the mantissa part. Please refer to FIG. 4, which is a diagram illustrating compressing floating-point numbers according to an embodiment of the arithmetic unit 110 of the present invention. In FIG. 4, each floating-point number is compressed into two fixed-point mantissas m1 and m2 of 2-bit 2's complement numbers, and then two 7-bit floating-point numbers, namely, scales (or scaling factors) r1 and r2, are compressed for each block. Next, the integer operations among m1, m2, r1 and r2 are performed for each floating-point number, so that “m1×r1+m2×r2” has the minimum mean square error with the floating-point number. Please note that the fixed-point mantissas m1 and m2 can be signed integers or unsigned integers.

In addition, the invention does not limit the number of m and r. For example, the arithmetic unit 110 may be arranged to perform the following steps: obtaining b floating-point numbers f1-fb, where b is a positive integer greater than 1; extracting k common scaling factors r1-rk for the b floating-point numbers, where k is a positive integer equal to or greater than 1; compressing each floating-point number fi in the b floating-point numbers into k fixed-point mantissas mi_1-mi_k, to generate b×k fixed-point mantissas mi_j, where i is a positive integer not greater than b, and j is a positive integer not greater than k; and outputting a compression result, wherein the compression result comprises the k common scaling factors r1-rk and the b×k fixed-point mantissas mi_j representing b compressed floating-point numbers cf1-cfb.

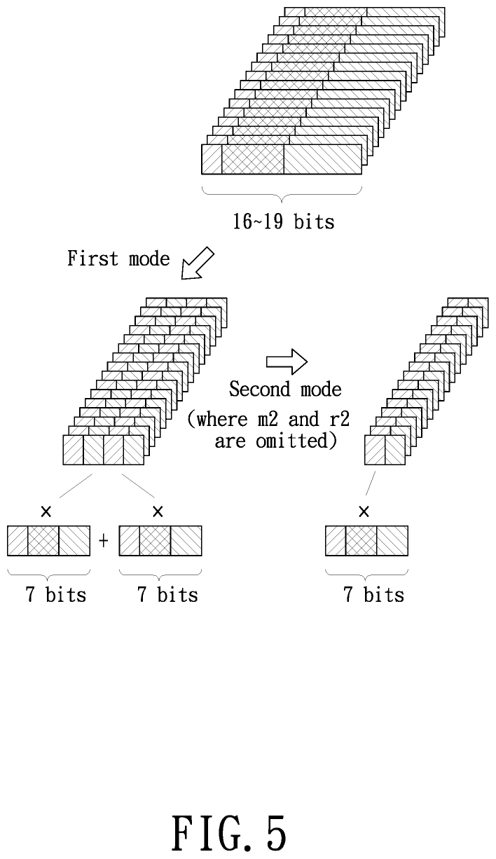

Please refer to FIG. 5, which is a diagram illustrating the compression processing of the arithmetic unit 110 according to another embodiment of the present invention. As shown in FIG. 5, the memory 114 of the arithmetic device 100 can store two sets of multiple sets of batch norm coefficients, respectively corresponding to two floating-point number compression processing modes, in which the first mode is the complete operation shown in FIG. 4, while the second mode deliberately ignores the (m2×r2) term to reduce the computational complexity. The arithmetic unit 110 can determine whether to choose the first mode or the second mode according to the current state of the arithmetic device 100 (e.g., whether the electronic device is found overheating or overload), and can also select according to the accuracy requirements of the application program in use. For example, when the current temperature of the arithmetic device 100 is too high and it is necessary to cool down, the second mode may be selected so that the arithmetic unit 110 can operate in a low-power and low-temperature state. In addition, when the arithmetic device 100 is a mobile device and is in the low-power state, the second mode may be selected to extend the standby time of the mobile device. In addition, if the arithmetic unit 110 is performing high-precision operations, the first mode may be selected to further improve the operational accuracy.

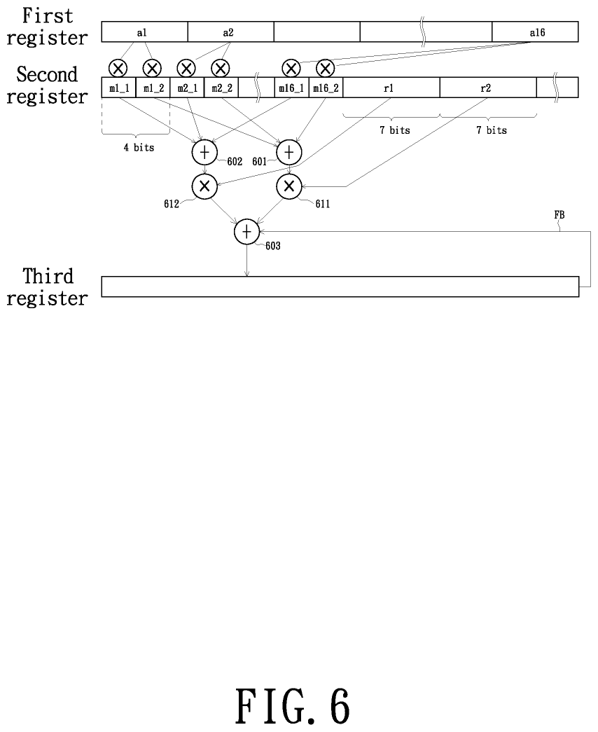

Please refer to FIG. 6, which is a diagram illustrating the floating-point multiplication of weight values and activation values by using an arithmetic unit and register according to an embodiment of the present invention. The first register, the second register and the third register may correspond to the first register 111, the second register 112 and the third register 113 depicted in FIG. 2 respectively. The multiplier and adder may correspond to the arithmetic unit 110 depicted in FIG. 2. As shown in FIG. 6, for each floating-point number, the second register stores the above scaling factors r1, r2 and the fixed-point mantissas m1_1, m1_2, etc. corresponding to the 2's complement, each being 2 bits. The first register stores activation values a1, . . . , a14, a15, and a16. Under the framework of FIG. 6, a1 is multiplied by m1_1 and m1_2 respectively, and a2 is multiplied by m2_1 and m2_2 respectively, and so on, and a16 is multiplied by m16_1 and m16_2 respectively. These multiplication results are added by adders 601 and 602, and then operated by multipliers 611 and 612 and adder 603 respectively. Compared with related art techniques, the present invention can simplify the hardware architecture, thus saving the power consumption and time on storing and transmitting data.

Furthermore, in order to ensure that the required accuracy is well maintained after the compressing of the floating-point number, the invention may check the compression error before generating the compression result, such as generating a quasi-compression result, which comprises k common scaling factors r1-rk and b×k fixed-point mantissas mi_j. Then, a compression error can be calculated according to the quasi-compression result, and a threshold can be set. Finally, the quasi-compression result is adjusted according to the compression error and the threshold as the compression result.

Specifically, the compression error Ei can be calculated for each floating-point number fi in b floating-point numbers according to the following equation:

$$Ei = fi - {\sum }_{j = 1}^{k} ( rj \text{?} mi\_j )$$

$$\text{?} \text{indicates text missing or illegible when filed}$$

Next, calculate the sum of the squares SE of b errors E1-Eb according to the following equation:

$$SE = {\sum }_{i = 1}^{b} Ei \hat{} 2$$

Then compare the sum of squares with a threshold value, wherein if the sum of squares is not greater than the threshold value (which means that the compression error is small), the quasi-compression result is outputted as the compression result. Otherwise, if the sum of squares is greater than the threshold, the quasi-compressed result will be regenerated, for example, the compressed result may be iteratively processed. Iterative processing may comprise the Heuristic algorithm, Randomized algorithm, or Brute-force algorithm, and the Heuristic algorithm further comprises the Evolutionary algorithm or Simulated annealing algorithm. For example, by using an Evolutionary algorithm, one bit of the scaling factors r1 and r2 can be changed (e.g., mutated). If the Simulated annealing algorithm is used, the scaling factors r1 and r2 can be respectively increased or decreased by a small value d, resulting in the scaling factors after four different sets of iterations: “r1+d, r2+d”, “r1+d, r2−d”, “r1−d, r2+d” or “r1−d and r2−d”. If the Randomized algorithm is used, for example, a random number function can be used to generate the scaling factors r1 and r2. If the Brute-force algorithm is used, for example, if r1 and r2 are 7 bits respectively, there are 14th power of 2 (2¹⁴) combinations of r1 and r2 to be iteratively checked. The above algorithms are merely for illustrative purposes, and are not meant to limit the scope of the present invention. For example, although the Evolutionary algorithm and Simulated annealing algorithm are arguably the most common types of the Heuristic algorithms, others algorithms such as Bee colony algorithm, Ant colony algorithm, whale optimization algorithm, etc. are not excluded. For example, in addition to mutation operations, the Evolutionary algorithms may also conduct selection operations and crossover operations, but the details thereof are omitted here for brevity. It should be understood by those skilled in the art that the aforementioned algorithms can be replaced with other types of algorithms.

The present invention does not limit the way of generating the threshold. In addition to the threshold of absolute value, another approach is to use a relative threshold, which can be summarized as the following steps: generating common scaling factors r1′-rk′ for b floating-point numbers; compressing each floating-point number fi in the b floating-point numbers into k fixed-point mantissas mi_1′-mi_k′ to generate b×k fixed-point mantissas mi_j′; and calculating a compression error Ei′ for each floating-point number fi in the b floating-point numbers according to the following equation:

$$\\ {Ei}^{{}_{} ′} = fi - {\sum }_{j = 1}^{k} ( {rj}^{{}_{} ′} \times {mi\_j}^{{}_{} ′} )$$

Next, calculate the sum of squares SE′ of b errors E1′-Eb′ according to the following equation:

$$\\ {SE}^{{}_{} ′} = {\sum }_{i = 1}^{b} {Ei}^{{}_{} ′} \hat{} 2$$

and then set the threshold as the compression error SE′. One skilled in that art should be readily to understand that this method of generating the threshold can be combined with the Heuristic algorithm (e.g., the Evolutionary algorithm, Simulated annealing algorithm, etc.), randomized algorithm, brute-force method, etc.

Alternatively, according to an embodiment of the present invention, the step of extracting common scaling factors r1-rk from the b floating-point numbers comprises: extracting common sign from the b floating-point numbers to make the b×k fixed-point mantissas mi_j unsigned mantissas; or only extracting the scaling factors r1-rk without extracting the sign from the b floating-point numbers, so that the b×k fixed-point mantissas mi_j are signed mantissas.

Alternatively, according to an embodiment of the present invention, the mantissas mi_j of the b×k fixed-point numbers may be 2's complement numbers or not.

Alternatively, according to an embodiment of the present invention, the method of compressing floating-point numbers further comprises: storing part of b×k fixed-point mantissas mi_j and part of scaling factors r1-rk in a register for subsequent operations, that is, some fixed-point mantissas and/or scaling factors are discarded, so as to further speed up the computation of the electronic device and reduce the power consumption thereof.

Alternatively, according to an embodiment of the present invention, the method of compressing floating-point numbers further comprises: storing all the b×k fixed-point mantissas mi_j and all the scaling factors r1-rk in a register, with some of the b×k fixed-point mantissas mi_j and some scaling factors r1-rk not participating in the operation, that is, not all the stored scaling factors participate in the operation. This can further speed up the operation of the electronic device and reduce the power consumption thereof.

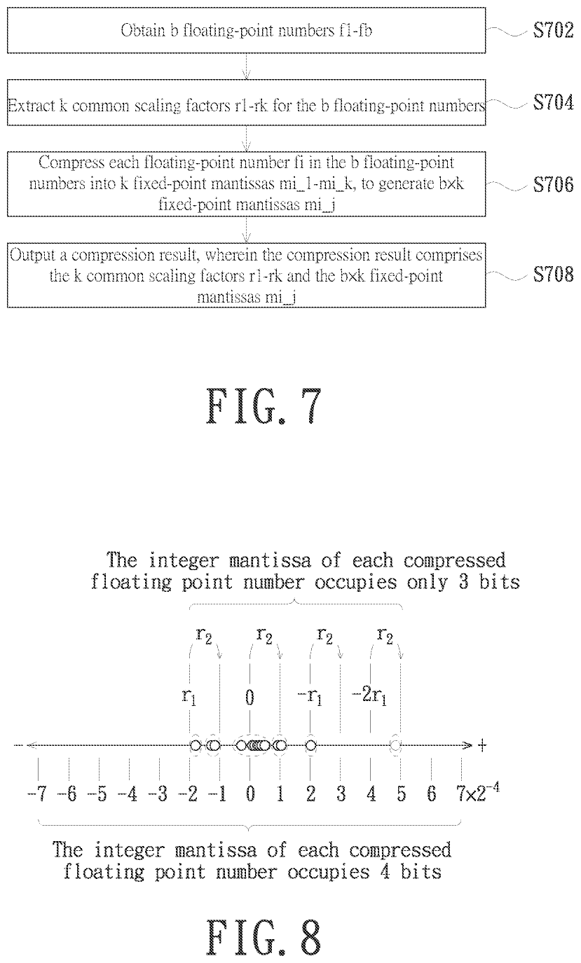

Please refer to FIG. 7, which is a flowchart of a floating-point number compression method according to an embodiment of the present invention. Please note that if a substantially same result can be obtained, these steps do not have to be executed in the execution order shown in FIG. 7. The floating-point arithmetic method shown in FIG. 7 can be adopted by the arithmetic device 100 or the arithmetic unit 110 shown in FIG. 2, and can be summarized as the following steps:
Step S702: Obtain b floating-point numbers f1-fb.
Step S704: Extract k common scaling factors r1-rk for the b floating-point numbers.
Step S706: Compress each floating-point number fi in the b floating-point numbers into k fixed-point mantissas mi_1-mi_k, to generate b×k fixed-point mantissas mi_j.
Step S708: Output a compression result, wherein the compression result comprises the k common scaling factors r1-rk and the b×k fixed-point mantissas mi_j.

As those skilled in the art can easily understand the details of each step in FIG. 7 after reading the above paragraphs, the more detailed descriptions will be omitted here for brevity.

To summarize, the present invention proposes a novel floating-point number compression method, which optimizes the efficiency in operations and provides the advantage of uniform quantization, in which the present invention uses the sum of two subword vectors with two scaling factor ratios to approximate each full-precision weight vector (i.e., the uncompressed floating-point numbers). More specifically, each subword is a low-bit integer (e.g., with 2 bits) and signed (2's complement), and each scaling factor is a low-bit floating point (LBFP) (e.g., 7 bits). The following will explain in detail why the present invention is superior in performance to Microsoft's MSFP algorithm.

In an embodiment of the invention, two multipliers (i.e., r1, r2) are adopted, and each floating-point number is compressed into two fixed-point mantissas (i.e., m1, m2), wherein the calculation efforts of multipliers is distributed among 16 weights, and each scaling factor is a low-bit floating-point number LBFP, which only involves low-bit operations.

Please refer to FIG. 8, which is a diagram illustrating the comparison between the method of the present invention and the method of MSFP, in which the results of compressing the weight vector in the present invention and the Microsoft's MSFP are compared. As can be seen from the figure, the present invention requires less quantization level than the MSFP solution, while realizing smaller quantization errors. The following is the merits of the present invention over the MSFP.

(I). Waste no quantization level: The method of compressing floating-point numbers according to the present invention adopts the 2's complement without wasting the quantization level. Comparatively, MSFP uses the sign magnitude, which consumes an additional quantization level (as positive 0 and minus 0 are both 0, and thus one of them is wasted. For example, 2 bits can only represent −1, 0, and 1, instead of four (22) different values), the impact of wasting a quantization level when the number of bits is low could be very noticeable.

(II). Adapt to skew distributions: The method of compressing floating-point numbers of the present invention utilizes the asymmetry of 2's complement to zero (e.g., the range of 2's complement is −2, −1, 0, 1) and the scaling to adapt to the asymmetric weight distribution of the weight vector. Comparatively, MSFP uses a sign magnitude whose range is symmetric to 0 (e.g., the 2-bit sign and value are −1, 0, 1, which is symmetric to 0), so the quantization level of MSFP is always symmetric, which leads to the need to spend additional quantization levels to adapt to the asymmetric weight distribution. As shown in FIG. 8, when the MSFP needs to use 15 quantization levels (4 bits), the present invention only uses 8 quantization levels (3 bits).

(III). Compatible with non-uniform distributions: The method of compressing floating-point numbers according to the present invention can provide non-uniform quantization levels by combining two multiples (r1, r2). Comparatively, the MSFP can only provide uniform quantization levels. That is, the method of compressing floating-point numbers of the present invention is more flexible when compressing non-uniformly distributed weights.

(IV). More flexible of quantization step size: In the method of compressing floating-point numbers of the present invention, the quantization step size is defined by two multiples (r1, r2), which are low bitwidth floating-point values. In contrast, the quantization step size of MSFP can only be a power-of-two value, such as 0.5, 0.25, 0.125, etc.

The following table shows the experimental data, in which the neural network image classification operation performed by the present invention is compared with that of the MSFP. As both approaches conduct the compression by treating 16 floating-point numbers as a block, the approach of the present invention demands fewer bits to reach the desired precision of classification. In contrast, the invention needs fewer bits per 16 floating-point numbers, and can achieve higher classification accuracy.

| | The invention | | MSFP | |
|---|---|---|---|---|
| Neural | 2's complement fixed | 4 | Sign (bits) | 1 |
| network | point mantissa m1 (bits) | | | |
| classi- | 2's complement fixed | 1 | Mantissa (bits) | 5 |
| fication | point mantissa m2 (bits) | | | |
| operations | Common scaling factor | 7 | Common exponent | 8 |
| | r1 (bits) | | (bits) | |
| | Common scaling factor | 7 | | |
| | r2 (bits) | | | |
| | Number of bits per 16 | 94 | Number of bits per 16 | 104 |
| | floating-point numbers | | floating-point numbers | |
| | Classification | 66 | Classification | 63 |
| | accuracy (%) | | accuracy (%) | |

The preferred embodiment of the number of bits of the fixed-point mantissas m1 and m2 of the present invention can be the following table, but it is not limited to the following table.

| | | | | | | | | |
|---|---|---|---|---|---|---|---|---|
| Bit number of m1 | 2 | 3 | 4 | 2 | 3 | 4 | 5 | 3 |
| Bit number of m2 | 1 | 1 | 1 | 2 | 2 | 2 | 2 | 3 |

A preferred embodiment of the bit numbers of the common scaling factors r1 and r2 of the present invention fare introduces in table below, but it is not a limitation to the scope of the present invention.

| r1 | Bit number of Sign | 1 | | | | | | |
|---|---|---|---|---|---|---|---|---|
| | Bit number of Exponent | 3 | 4 | 5 | 3 | 4 | 5 | 3 |
| | Bit number of Mantissa | 4 | 3 | 2 | 4 | 3 | 2 | 3 |
| r2 | Bit number of Sign | 1 | | | | | | |
| | Exponent | 3 | 4 | 5 | 3 | 3 | 3 | 3 |
| | Mantissa | 4 | 3 | 2 | 3 | 3 | 3 | 3 |

In view of the above, the invention can save storage space, reduce power consumption and speed up operation while meeting the accuracy requirements of various application programs. In addition, due to the adjustability between the first mode and the second mode, the electronic products adopting the proposed technical features can flexibly make a trade-off between a high-efficiency mode and a low-power mode, so that the electronic products can be applied in more areas. In addition, compared with the Microsoft MSFP as well as other existing technologies, the method of compressing floating-point numbers of the present invention can provide optimized operation efficiency and accuracy, which can reduce the power consumption and speed up the processing speed while also meeting the accuracy requirements of application programs.

What is claimed is:

1. A method of compressing floating-point numbers comprising:
A) obtaining b floating-point numbers f1-fb, where b is a positive integer greater than 1;
B) extracting k common scaling factors r1-rk for the b floating-point numbers, where k is a positive integer equal to or greater than 1, and the k common scaling factors r1-rk at least comprise a floating-point number with a mantissa;
C) compressing each floating-point number fi in the b floating-point numbers into k fixed-point mantissas mi_1-mi_k, to generate b×k fixed-point mantissas mi_j, where i is a positive integer not greater than b, and j is a positive integer not greater than k; and
D) outputting a compression result, wherein the compression result comprises the k common scaling factors r1-rk and the b×k fixed-point mantissas mi_j representing b compressed floating-point numbers cf1-cfb, and the value of each compressed floating-point number cfi is represented as cfi=Σⱼ₌₁^{k}(rj×mi_j).

2. The method of compressing floating-point numbers according to claim 1, wherein the arithmetic device further performs the following steps before performing Step D):
generating a quasi-compression result, wherein the quasi-compression result comprises the k common scaling factors r1-rk and the b×k fixed-point mantissas mi_j, and calculating a compression error for the quasi-compression result;
setting a threshold value; and
according to the compression error and the threshold value, adjusting the k common scaling factors r1-rk and the b×k fixed-point mantissas mi_j.

3. The method of compressing floating-point numbers according to claim 2, wherein the step of calculating the compression error for the quasi-compression result comprises:
calculating the compression error Ei for each of the b floating-point numbers fi according to the following equation:
$$\\ Ei = fi - {\sum }_{j = 1}^{k} ( rj \times mi\_j )$$
calculating a sum of squares SE of b errors E1-Eb according to the following equation:
$$\\ SE = {\sum }_{i = 1}^{b} Ei \hat{} 2 ;$$
and
comparing the sum of squares SE with a threshold;
wherein if the sum of squares SE is not greater than the threshold, the quasi-compression result is taken as the compression result.

4. The method of compressing floating-point numbers according to claim 2, wherein if the compression error is greater than the threshold, Steps b) and c) are re-executed.

5. The method of compressing floating-point numbers according to claim 4, wherein the step of adjusting the k common scaling factors r1-rk and the b×k fixed-point mantissas mi_j comprises:
iteratively performing one of Heuristic algorithm, Randomized algorithm, and Brute-force algorithm upon the k common scaling factors r1-rk and the b×k fixed-point mantissas mi_j.

6. The method of compressing floating-point numbers according to claim 2, wherein the step of setting the threshold comprises:
extracting common scaling factors r1′-rk′ from the b floating-point numbers;
compressing each floating-point number fi in the b floating-point numbers into k fixed-point mantissas mi_1′-mi_k′, to generate b×k fixed-point mantissas mi_j′;
calculating a compression error Ei′ for each floating-point number fi of the b floating-point numbers according to the following equation:
$$\\ {Ei}^{{}_{} ′} = fi - {\sum }_{j = 1}^{k} ( {rj}^{{}_{} ′} \times {mi\_j}^{{}_{} ′} ) ;$$
calculating a sum of squares SE′ of b errors E1′-Eb′ according to the following equation:
$$\\ {SE}^{{}_{} ′} = {\sum }_{i = 1}^{b} {Ei}^{{}_{} ′} \hat{} 2 ;$$
and
setting the threshold as the compression error SE′.

7. The method of compressing floating-point numbers according to claim 1, wherein the b×k fixed-point mantissas mi_j are all unsigned numbers.

8. The method of compressing floating-point numbers according to claim 1, wherein at least one of the b×k fixed-point mantissas mi_j is a signed number, and the numerical range expressed by the signed number is asymmetric with respect to 0.

9. The method of compressing floating-point numbers according to claim 8, wherein the signed number is a 2's complement number.

10. The method of compressing floating-point numbers according to claim 1, further comprising:
storing the b×k fixed-point mantissas mi_j and the k common scaling factors in a memory of a network server for remote downloads.

11. The method of compressing floating-point numbers according to claim 1, further comprising:
storing the b×k fixed-point mantissas mi_j and all the scaling factors r1-rk in a memory, with part of the b×k fixed-point mantissas mi_j and part of the scaling factors r1-rk not participating in operations.

12. The method of compressing floating-point numbers according to claim 1, where k is equal to 2, and each of the scaling factors r1-rk is floating-point numbers with no more than 16 bits.

13. An arithmetic device comprising a first register, a second register and an arithmetic unit, wherein the arithmetic unit comprises at least one multiplier and at least one adder, and the arithmetic unit is coupled to the first register and the second register, wherein:
the first register stores b activation values a1-ab, where b is a positive integer greater than 1;
the second register stores b compressed floating-point numbers cf1-cfb;
the b packed floating-point numbers comprise k common scaling factors r1-rk, where k is a positive integer equal to or greater than 1;
each of the b compressed floating-point numbers cfi comprises k fixed-point mantissas mi_1-mi_k, the b compressed floating-point numbers cfi have b×k fixed-point mantissas mi_j, where i denotes a positive integer not greater than b and j denotes a positive integer not greater than k, and the value of each compressed floating-point number cfi is expressed by: cfi=Σⱼ₌₁^{k}(rj×mi_j), and
the arithmetic unit calculates an inner product result of the b activation values (a1, a2, . . . , ab) and the b compressed floating-point numbers (cf1, cf2, . . . , cfb).

14. The arithmetic device according to claim 13, wherein the arithmetic device is configured to perform the following steps:
A) obtaining b floating-point numbers f1-fb, wherein b is a positive integer greater than 1;
B) generating k common scaling factors r1-rk for the b floating-point numbers, where k is a positive integer greater than 1, and the k common scaling factors r1-rk at least comprise a floating-point number with a mantissa;
C) compressing each floating-point number fi in the b floating-point numbers into k fixed-point mantissas mi_1-mi_k to generate b×k fixed-point mantissas mi_j, where i is a positive integer not greater than b, and j is a positive integer not greater than k; and
D) outputting a compression result, wherein the compression result comprises the k common scaling factors r1-rk and the b×k fixed-point mantissas mi_j representing b compressed floating-point numbers cf1-cfb, and the value of each compressed floating-point number cfi is represented by cfi=Σⱼ₌₁^{k}(rj×mi_j).

15. The arithmetic device according to claim 14, wherein the arithmetic device further performs the following steps before performing Step D):
calculating a quasi-compression result, wherein the quasi-compression result comprises the k common scaling factors r1-rk and the b×k fixed-point mantissas mi_j;
calculating a compression error for the quasi-compression result;
setting a threshold value; and
adjusting the k common scaling factors r1-rk and the b×k fixed-point mantissas mi_j according to the compression error and the threshold value.

16. The arithmetic device according to claim 15, wherein the step of calculating the compression error for the quasi-compression result comprises:
calculating a compression error Ei for each floating-point number fi in the b floating-point numbers according the following equation:
$$\\ Ei = fi - {\sum }_{j = 1}^{k} ( rj \times mi\_j ) ;$$
calculating a sum of squares SE of b errors E1-Eb according to the following equation:
$$\\ SE = {\sum }_{i = 1}^{b} Ei \hat{} 2 ;$$
and
comparing the sum of squares SE with a threshold;
wherein if the sum of squares SE is not greater than the threshold, the quasi-compression result is taken as the compression result.

17. The arithmetic device according to claim 15, wherein if the compression error is greater than the threshold, Steps b) and c) are re-executed.

18. The arithmetic device according to claim 17, wherein the step of adjusting the k common scaling factors r1-rk and the b×k fixed-point mantissas mi_j comprises:
iteratively performing one of Heuristic algorithm, Randomized algorithm, and Brute-force algorithm upon the k common scaling factors r1-rk and the b×k fixed-point mantissas mi_j.

19. The arithmetic device according to claim 14, wherein the step of setting the threshold comprises:
extracting common scaling factors r1′-rk′ from the b floating-point numbers;
compressing each floating-point number fi in the b floating-point numbers into k fixed-point mantissas mi_1′-mi_k′, to generate b×k fixed-point mantissas mi_j′;
calculating a compression error Ei′ for each floating-point number fi of the b floating-point numbers according to the following equation:
$$\\ {Ei}^{{}_{} ′} = fi - {\sum }_{j = 1}^{k} ( {rj}^{{}_{} ′} \times {mi\_j}^{{}_{} ′} ) ;$$
calculating the sum of squares SE′ of b errors E1′-Eb′ according to the following equation:
$$\\ {SE}^{{}_{} ′} = {\sum }_{i = 1}^{b} {Ei}^{{}_{} ′} \hat{} 2 ;$$
and
setting the threshold as the compression error SE′.

20. The arithmetic device according to claim 13, wherein the b activation values a1-ab are integers, fixed points, or mantissas of MSFP block floating-point numbers.

21. The arithmetic device according to claim 13, wherein all the b×k fixed-point mantissas mi_j and all the common scaling factors r1-rk are stored in the second register, with part of the b×k fixed-point mantissas mi_j and part of the scaling factors r1-rk not participating in operations.

22. A computer-readable storage medium storing computer-readable instructions executable by a computer, wherein when being executed by the computer, the computer-readable instructions trigger the computer to output b compressed floating-point numbers, where b is a positive integer greater than 1; the method comprising:
A) generating k common scaling factors r1-rk, where k is a positive integer equal to or greater than 1, wherein the k common scaling factors r1-rk at least comprise a floating-point number with a scaling factor exponent and a scaling factor mantissa;
B) generating k fixed-point mantissas mi_1-mi_k to generate b×k fixed-point mantissas mi_j, where i is a positive integer not greater than b, and j is a positive integer not greater than k; and
C) outputting the k common scaling factors r1-rk and the b×k fixed-point mantissas mi_j representing b compressed floating-point numbers cf1-cfb, wherein the value of each compressed floating-point number cfi is represented by cfi=Σⱼ₌₁^{k}(rj×mi_j).
